(19) United States
(12) Patent Application Publication
(10) Pub. No.: US 2021/0045198 A1
(43) Pub. Date: Feb. 11, 2021

(54) Method for Inductive Heat Treatment, and Process-Engineering Arrangement for Execution of the Method

(71) Applicant: Robert Bosch GmbH, Stuttgart (DE)

(72) Inventors: Hermann Autenrieth, Ruit (DE); Jelena Pavlovic-Krstic, Asperg (DE); Marcus Hansel, Altdorf (DE); Michael Cesinger, Lohr Am Main (DE)

(21) Appl. No.: 16/985,944

(22) Filed: Aug. 5, 2020

(30) Foreign Application Priority Data
Aug. 7, 2019 (DE) 10 2019 211 862.3

(51) Int. Cl. H05B 6/06; H05B 1/02

(52) U.S. Cl. CPC H05B 6/06; H05B 1/023

(57) ABSTRACT

A method for an inductive heat treatment of a workpiece includes determining at least one material attribute of the workpiece, and performing the inductive heat treatment controlled in dependence on the determined at least one material attribute of the workpiece.

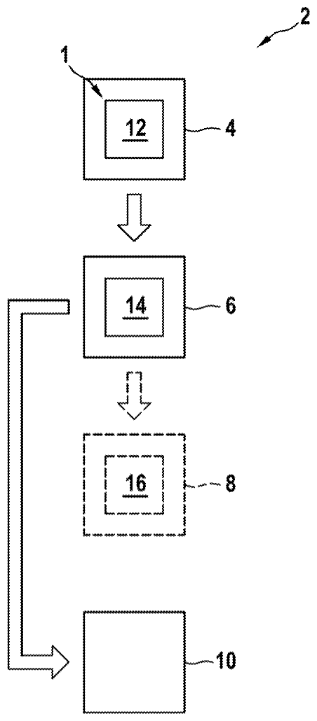

This application claims priority under 35 U.S.C. § 119 to patent application no. DE 10 2019 211 862.3, filed on Aug. 7, 2019 in Germany, the disclosure of which is incorporated herein by reference in its entirety.

The disclosure relates to a method for inductive heat treatment, and to a process-engineering arrangement for execution of the method.

### BACKGROUND

Inductive heat treatment, in particular induction hardening, is known from the prior art for the spatially limited heat treatment of workpieces. In this case, a magnetic field is generated by means of an induction coil, as a result of which eddy currents are generated locally on the nearby workpiece, in a boundary layer. As a result, the surface of the workpiece heats up, in a spatially limited manner, to the necessary process temperature at which an optimization of a workpiece property, for example hardness, is effected.

Frequently, there is a diffusion of an alloy composition and microstructural attributes of the starting material, in particular since these can vary across material batches. Consequently, the workpieces enter the heat treatment process with varying quality. Since, in the case of induction controlled by power, current or voltage, this variation results in a variation of the eddy currents, and thus of the process temperature, the workpiece property actually achieved thus sometimes deviates considerably from a specified property.

According to the prior art, these workpiece properties are tested after heat treatment has been performed. The disadvantage of this procedure is that workpieces that do not meet the specification are rejects or have to be reworked. Both are highly resource-intensive and costly.

### SUMMARY

In contrast to the above, the disclosure is based on the object of creating a method for inductive heat treatment by means of which a specification of the workpiece that is achievable by heat treatment can be achieved with a lesser resource requirement, despite varying material attributes of the input workpieces. Furthermore, the disclosure is based on the object of creating a process-engineering arrangement by means of which a specification of the workpiece that is achievable by heat treatment can be achieved with a lesser resource requirement, despite varying material attributes of the input workpieces.

A method for the, in particular local, inductive heat treatment of a workpiece has a step “inductive heat treatment of the workpiece”. In addition, it has a step “determining or testing at least one material attribute of the workpiece”, which, in particular, is effected by means of a test means. According to the disclosure, the “inductive heat treatment”, in particular the process control thereof, is effected after, or at least in sections after, the “determining” step, controlled in dependence on the determined material attribute or attributes. The control is effected, in particular, by means of a control means.

The method thus enables the controller or control means to react directly to the variation of the material attribute or attributes. Each input workpiece is thus subjected to an individual heat treatment, such that more of the output workpieces attain the specification to be achieved by the heat treatment, and fewer rejects are produced. This reduces the resource requirement and costs.

The material attribute is, in particular, a structure, a mechanical property such as hardness or strength, a hardness depth, a μ-structure or—indirectly—a distortion, or there are, for example, internal stresses of the workpiece.

Workpieces that may be cited are, in particular, those that require locally increased strength and/or wear protection, for example induction-hardened shafts, eccentrics, gear wheels or hydraulic valves. The specification is a hardness or strength. In addition, they are workpieces that are locally heat-treated, for example to enhance function, such as, for example, magnetically optimized valve sleeves.

In a development of the method, at least the two steps of the method mentioned above are effected in one and the same method line or process line, i.e. “in-line”. In other words, at least the step “determining” is effected in a spatial and temporal framework with the step “inductive heat treatment”.

In a development, the step “determining” is effected non-destructively and/or contactlessly, which means a corresponding gain in time and a reduced resource requirement.

In a development, the step “determining” is effected by means of an inductor and a magnetic field sensor. The former may be activated by current, in particular alternating current, voltage, in particular alternating voltage, or power. The latter may be, for example, a Hall sensor or an arrangement thereof.

In a development of the method, the step “determining” comprises steps “activating an inductor arranged at the workpiece” and “sensing a magnetic field, in dependence on the activating step and on the material attribute”.

A result of the “determining” step is then used as input in the control of the inductive heat treatment. Its direct control thus depends on the magnetic property or magnetic properties of the workpiece measured in-line beforehand.

In a development, the method includes a step “calibrating”, in particular calibrating the test equipment.

Calibrating may be effected as follows. Firstly, “activating the inductor in the absence of workpieces”, is effected, then “sensing a first magnetic field of the inductor, induced in dependence on the activation, in particular by the magnetic field sensor”, during or after which “storing the first magnetic field, in dependence on the activation, in a control means, as a characteristics map or characteristic curve” is effected.

In addition, “input of a plurality of workpieces having a known material attribute”, is effected, then “activating the inductor with the respective workpiece”. In this case, owing to the resulting first magnetic field, an eddy current is induced near the surface on the workpiece, which in turn, depending on the workpiece attribute or attributes, results in a second magnetic field of the workpiece, opposite in direction to the first magnetic field. The first and the second magnetic fields add up to a resulting magnetic field. This is followed by the steps “sensing the resulting magnetic field” and “storing the resulting magnetic field, in dependence on the activation and the known material attribute or attributes, in the control means, as a characteristics map”. In addition, a step “determining and storing the second magnetic field from the resulting magnetic field and the first magnetic field” and a step “storing the second magnetic field in dependence on the activation and the known material attribute or attributes, in the control means, as a characteristics map” may be effected.

A plurality of material attributes may be determined by corresponding calibration.

A process-engineering arrangement, in particular a process line, has a determination means for executing the method as described above. At least the step “determining at least one material attribute of the workpiece” can be executed by means of this means. Furthermore, a heat treatment means is provided, by means of which at least the step “inductive heat treatment of the workpiece” can be executed. The latter step in this case can be controlled in dependence on the determined material attribute or attributes, with the advantages already mentioned, by means of a control means of the arrangement.

Preferably, the determination means is continuously integrated into the arrangement and execution of the method. In particular, it is arranged in spatial unity with the heat treatment means and the control means.

In a development, for the purpose of the aforementioned control, a temperature regulation is stored in the control means in dependence on the determined material attributes or attributes for the control of the inductive heat treatment. Preferably, a temperature sensing means is provided for sensing the temperature.

In a development, the arrangement has a test means, to enable a specification of the workpiece that is to be achieved by the inductive heat treatment to be randomly tested on a sub-quantity of the treated workpieces.

### BRIEF DESCRIPTION OF THE DRAWING

An exemplary embodiment of the method according to the disclosure is represented in the FIGURE. The disclosure is now explained in greater detail on the basis of this FIGURE.

### DETAILED DESCRIPTION

The FIGURE shows a method 1 for inductive heat treatment of a workpiece, in particular for hardening it. Also represented is a process line 2, in which method 1 is executed. The process line 2 has the stations workpiece intake 4, inductive heat treatment 6, random testing 8 and goods output 10.

A first step of the method 1, “determining at least one material attribute of the workpiece” 12, is effected in the goods intake 4 by means of a test means, which in particular has at least one inductor and at least one magnetic field sensor. The test means is used to determine at least one of the material attributes structure, hardness, μ-structure of hardness or hardness depth, strength, or—indirectly—a distortion, or internal stresses of the workpiece are determined. An intake state of the workpiece is thereby determined, before the inductive heat treatment, which is then subsequently controlled in dependence on a determination result. The workpiece is then transferred into the inductive heat treatment 6 section of process line 2. Here the step of method 1, “inductive heat treatment, controlled in dependence on the determined material attribute or attributes” 14, is effected.

In the exemplary embodiment represented, this is realized by a temperature-regulated process control in dependence on the determination result determined in step 12.

Following completion of the inductive heat treatment, the workpiece may optionally be transferred to random, in particular destructive, testing 8. To ensure that the result of the inductive heat treatment 6 is not subject to drift over time, workpieces in this case may be randomly tested for hardness or structure or, in general terms, for a required specification.

Alternatively, and as a rule, following completion of inductive heat treatment 6 the workpiece is transferred into the final station of the process line 2, goods output 10.

The method 1 according to the disclosure executed in the process line 2 thus enables the process of inductive heat treatment 6 to be controlled directly by means of magnetic or magnetic field properties of the workpiece that are measured in-line.

By creation of a direct feedback of the inductive heat treatment to the material attribute, it is possible, in particular, to effect very precise local adjustment of the structure of the workpiece.

Disclosed is a method for inductive heat treatment of a workpiece obvious, in which firstly at least one material attribute of the workpiece is determined, and then the inductive heat treatment is controlled in dependence on the at least one material attribute. Also disclosed is a process-engineering arrangement comprising a determination means, a heat treatment means and a control means therefor.

What is claimed is:

1. A method for an inductive heat treatment of a workpiece, comprising:
determining at least one material attribute of the workpiece; and
performing the inductive heat treatment controlled in dependence on the determined at least one material attribute.

2. The method according to claim 1, wherein a process engineering arrangement performs at least one of (i) the determining the at least one material attribute, and (ii) the performing the inductive heat treatment.

3. The method according to claim 1, wherein the determining the at least one material attribute comprises:
determining the at least one material attribute of the workpiece non-destructively and/or contactlessly.

4. The method according to claim 1, wherein the determining the at least one material attribute comprises:
determining the at least one material attribute of the workpiece with an inductor and a magnetic field sensor.

5. The method according to claim 4, wherein the determining the at least one material attribute further comprises:
arranging an inductor near the workpiece;
activating the arranged inductor; and
sensing a magnetic field with the magnetic field sensor in dependence on the activating the inductor as a test result or a determination result.

6. The method according to claim 1, further comprising:
calibrating a test device or a determination device based on the determined at least one material attribute.

7. A process-engineering arrangement, comprising:
a determination device configured to determine at least one material attribute of a workpiece;
a heat treatment device configured to perform an inductive heat treatment of the workpiece; and
a control device operably connected to the determination device and the heat treatment device and configured (i) to control the determination device to determine the at least one material attribute, and (ii) to control the heat treatment device to perform the inductive heat treatment in dependence on the determined at least one material attribute.

8. The process-engineering arrangement according to claim 7, wherein the control device is configured to store a temperature regulation in dependence on the determined at least one material attribute for controlling the inductive heat treatment.

9. The process-engineering arrangement according to claim 7, further comprising:
a test device configured to test a required specification of the workpiece after the inductive heat treatment.

10. The process-engineering arrangement according to claim 9, wherein the test is a destructive test of the workpiece.
